(19) United States
(12) Patent Application Publication
(10) Pub. No.: US 2015/0282110 A1
(43) Pub. Date: Oct. 1, 2015

(54) METHOD OF MEASURING TERMINAL POSITION USING TAG AND TERMINAL THEREOF

(71) Applicant: INDUSTRY FOUNDATION OF CHONNAM NATIONAL UNIVERSITY, Gwangju (KR)

(72) Inventors: Intae Hwang, Yongin-si (KR); Bora Kim, Mokpo-si (KR); Sangmi Moon, Gwanju (KR); Saransh Malik, Gwangju (KR); Chilwoo Lee, Gwangju-si (KR); Seungkyu Kim, Seoul (KR)

(21) Appl. No.: 14/112,796

(22) PCT Filed: Sep. 5, 2013
(86) PCT No.: PCT/KR2013/008011

§ 371 Date: Jun. 10, 2015

(30) Foreign Application Priority Data
Dec. 10, 2012 (KR) 10-2012-0142449

(51) Int. Cl. H04W 64/00; H04W 52/28; H04B 5/00

(52) U.S. Cl. CPC H04W 64/00; H04B 5/0062; H04W 52/283

(57) ABSTRACT

Provided is a method of measuring a terminal position using a tag and a terminal thereof. A first terminal measures a first position by reading a tag having a predetermined position, and a position change is continuously detected using a sensor to measure a changed second position. When the first terminal or a second terminal wirelessly communicates each other, communication power strength is gradually changed, minimum communication power strength capable of communicating is measured, and the first or second terminal measures a third position of the second terminal based on the second position in consideration of a communication range according to the minimum communication power strength. As a result, it is possible to accurately determine a terminal position.

### TECHNICAL FIELD

The present invention relates to position measurement technology, and more specifically, a method of measuring a terminal position using a tag and a terminal thereof which can measure a position of a corresponding terminal or other terminal using a corresponding tag or a position of the tag when a terminal recognizes a tag having a predetermined position or a tag reader having a predetermined position recognizes a tag inside the terminal.

### BACKGROUND ART

Recently, a global positioning system (GPS) has been introduced as a position tracking method. In the GPS, 24 satellites in an earth orbit transmit radio signals so that it is possible to measure a position or movement speed of a target object. However, such a GPS has a position measurement error of several tens of meters (m) to several hundreds of meters (m), and it is difficult to measure a position in indoor areas or out of service area.

A method of recognizing a terminal position has been proposed for a mobile communication terminal such as a cellular phone or a smartphone in which a position of the terminal is determined by wireless communication with a plurality of base stations. However, such a method includes a larger error than the GSP, and it is difficult to measure a position in indoor areas or out of service area.

Moreover, in order to measure a position in areas having limited wireless communication such as indoor areas, there is a cost burden since it is necessary to purchase additional devices for position measurement, and accuracy in position measurement decreases due to influences of obstacles or a human body.

### DISCLOSURE

### Technical Problem

The invention has been made in view of the above-mentioned problems and the invention provides a method of measuring a terminal position using a tag and the terminal thereof which can minimize costs necessary for position determination and significantly improve accuracy in position determination by recognizing a position of a corresponding terminal or other terminal with respect to a corresponding tag or a position of the tag when a terminal recognizes a tag having a predetermined position or a tag reader having a predetermined position recognizes a tag inside the terminal.

### Technical Solution

One aspect of the present invention provides a method of measuring a terminal position using a tag, including measuring a first position of a first terminal such that the first terminal reads a tag having a predetermined position and measures the first position corresponding to the position of the tag, measuring a second position of the first terminal such that the first terminal continuously detects a position change from the first position using a sensor and measures the changed second position of the first terminal, measuring communication power such that, when the first or second terminal wirelessly communicates each other, communication power strength is gradually changed, and minimum communication power strength capable of communicating is measured, and measuring a third position of the second terminal by the first or second terminal based on the second position in consideration of a communication range according to the measured minimum communication power strength.

In the measuring of the first position, the first terminal may read position information included in the tag, determine the position of the tag, and measure the first position corresponding to the determined position of the tag.

In the measuring of the first position, the first terminal may read information included in the tag, access a position information server that provides position information of the tag, determine the position of the tag, and measure the first position corresponding to the determined position of the tag.

Another aspect of the present invention provides a method of measuring a terminal position using a tag, including measuring a first position of a first terminal such that a tag reader having a predetermined position reads a tag included in the first terminal and the first position of the first terminal is measured corresponding to the position of the tag reader, measuring a second position of the first terminal such that the first terminal continuously detects a position change from the first position using a sensor and measures the changed second position of the first terminal, measuring communication power such that, when the first or second terminal wirelessly communicates each other, communication power strength is gradually changed, and minimum communication power strength capable of communicating is measured, and measuring a third position of the second terminal by the first or second terminal based on the second position in consideration of a communication range according to the measured minimum communication power strength.

In the measuring of the first position, the first terminal may receive position information stored in the tag reader, determine the position of the tag reader, and measure the first position corresponding to the determined position of the tag reader.

In the measuring of the first position, the first terminal may receive information included in the tag reader, access a position information server that provides position information of the tag reader, determine the position of the tag reader, and measure the first position corresponding to the determined position of the tag reader.

In the measuring of the second position, the first terminal may detect the position change of the first terminal using a gravity sensor, an acceleration sensor, a gyro sensor, or an optical sensor.

In the measuring of the second position, the plurality of first terminals and the second terminal may wirelessly communicate each other and respectively measure minimum communication power strength capable of communicating, and in the measuring of the third position, the third position may be measured based on each position of the plurality of first terminals in consideration of a communication range according to each minimum communication power strength.

In the measuring of the communication power, the first or second terminal may wirelessly communicate via a wireless personal area network (WPAN) and measure minimum communication power strength capable of communicating.

In the measuring of the communication power, the second terminal may broadcast a message for position determination, and the first terminal, that has received the message for position determination, gradually change communication power strength, and transmit a response message to the second terminal so that minimum communication power strength capable of communicating may be measured.

In the measuring of the third position, based on the second position, a distance or a range in which the second terminal is positioned may be measured.

The method further includes, measuring second power such that, when the second or third terminal wirelessly communicates each other, communication power strength is gradually changed, and minimum communication power strength capable of communicating is measured, and measuring a fourth position of the third terminal such that the second or third terminal measures the fourth position of the third terminal based on the third position in consideration of a communication range according to the minimum communication power strength measured in the measuring of the second power.

The method further includes, measuring third power such that, when the first or third terminal wirelessly communicates each other, communication power strength is gradually changed, and minimum communication power strength capable of communicating is measured, and measuring a fifth position of the third terminal such that the first, second, or third terminal measures the fifth position of the third terminal based on the second and third positions in consideration of a communication range according to the minimum communication power strength measured in the measuring of the third power and the fourth position.

The first, second, or third position may include at least one of latitude, longitude, and height information from a reference plane.

Still another aspect of the present invention provides a terminal for measuring a position using a tag including, a wireless communication unit for wireless communication, a tag reader configured to read information of a tag having a predetermined position, a sensing unit configured to detect position movement, a communication power measuring unit configured to, when wireless communication is performed with other terminal through the wireless communication unit, gradually change communication power strength, and measure minimum communication power strength capable of communicating, and a position measuring unit configured to measure a first position using the information read by the tag reader, measure a changed second position by continuously detecting a position change from the first position by the sensing unit, and measure a third position of a second terminal based on the second position in consideration of a communication range according to the minimum communication power strength measured by the communication power measuring unit.

When the tag reader reads position information included in the tag, the position measuring unit may access a position information server that provides position information of the tag using the read information through the wireless communication unit, determine the position of the tag, and measure the first position corresponding to the determined position of the tag.

When the tag reader reads position information included in the tag, the position measuring unit may access a position information server that provides position information of the tag using the read information through the wireless communication unit, determine the position of the tag, and measure the first position corresponding to the determined position of the tag.

Yet another aspect of the present invention provides a position measuring terminal using a tag including, a wireless communication unit for wireless communication, a tag that can be recognized, a sensing unit configured to detect position movement, a communication power measuring unit configured to, when wireless communication is performed with other terminal through the wireless communication unit, gradually change communication power strength, and measure minimum communication power strength capable of communicating, and a position measuring unit configured to, when a tag reader having a predetermined position reads the tag, measure a first position corresponding to the position of the tag reader, measure a changed second position by continuously detecting a position change from the first position by the sensing unit, and measure a third position of a second terminal based on the second position in consideration of a communication range according to the minimum communication power strength measured by the communication power measuring unit.

The position measuring unit may receive position information stored in the tag reader through the wireless communication unit, determine the position of the tag reader, and measure the first position corresponding to the determined position of the tag reader.

The position measuring unit may receive information included in the tag reader through the wireless communication unit, access a position information server that provides position information of the tag reader, determine the position of the tag reader, and measure the first position corresponding to the determined position of the tag reader.

The sensing unit may detect the position change using a gravity sensor, an acceleration sensor, a gyro sensor, or an optical sensor.

The communication power measuring unit may measure minimum communication power strength capable of communicating through wireless communication via a wireless personal area network (WPAN).

When a message for position determination broadcast from the second terminal is received through the wireless communication unit, the communication power measuring unit may gradually change communication power strength, transmit a response message to the second terminal through the wireless communication unit, and measure minimum communication power strength capable of communicating.

The first, second, or third position may include at least one of latitude, longitude, and height information from a reference plane.

Yet another aspect of the present invention provides a computer readable recording medium storing a program that executes the method of measuring the terminal position using the tag.

### Advantageous Effects

The method of measuring a terminal position using a tag and the terminal thereof may have the following advantages.

First, it is possible to accurately measure positions of a plurality of terminals since a position of a specific terminal is determined based on a tag or a tag reader which has an accurately determined position, a position change due to terminal movement is detected using a sensor, and a position of other terminal is determined based on a position of a terminal that moves.

Second, it is possible to improve convenience for position measurement. This is because the specific terminal needs tag recognition but other terminal, that recognizes a position thereof using a corresponding specific terminal, does not necessarily recognize the tag.

Third, it is possible to accurately measure positions of the plurality of terminals regardless of radio environments, for example, indoor areas, since the terminal in which a position thereof is determined once can be used for determining a position of other terminal.

### DESCRIPTION OF DRAWINGS

FIG. 1 is a diagram illustrating a configuration of a position measurement system according to an embodiment of the invention.

FIG. 2 is a diagram illustrating a configuration of a position measurement system according to another embodiment of the invention.

FIG. 3 is a diagram illustrating a configuration of a position measurement system according to still another embodiment of the invention.

FIG. 4 is a diagram illustrating a configuration of a terminal according to an embodiment of the invention.

FIG. 5 is a diagram illustrating a configuration of a terminal according to another embodiment of the invention.

FIG. 6 is a diagram illustrating an example of terminal position measurement according to an embodiment of the invention.

FIG. 7 is a flowchart illustrating position measurement operations according to an embodiment of the invention.

### MODES OF THE INVENTION

The following descriptions will be made focusing on configurations necessary for understanding embodiments of the invention. Therefore, descriptions of other configurations will be omitted in order not to obscure gist of the invention.

Moreover, terms and words used in this specification and claims should not be interpreted as limited to commonly used meanings or meanings in dictionaries and should be interpreted with meanings and concepts which are consistent with the technological scope of the invention based on the principle that the inventors have appropriately defined concepts of terms in order to describe the invention in the best way. Therefore, since the embodiments described in this specification and configurations illustrated in drawings are only exemplary embodiments and do not represent the overall technological scope of the invention, it is understood that the invention covers various equivalents, modifications, and substitutions at the time of filing of this application.

The invention proposes technology that can measure a position of a corresponding terminal using a position of a tag or a tag reader, and measure a position of other terminal with respect to a determined position of the terminal when the terminal recognizes the tag or the tag reader recognizes a tag included in the terminal. Hereinafter, the embodiments of the invention will be described in detail with reference to the accompanying drawings.

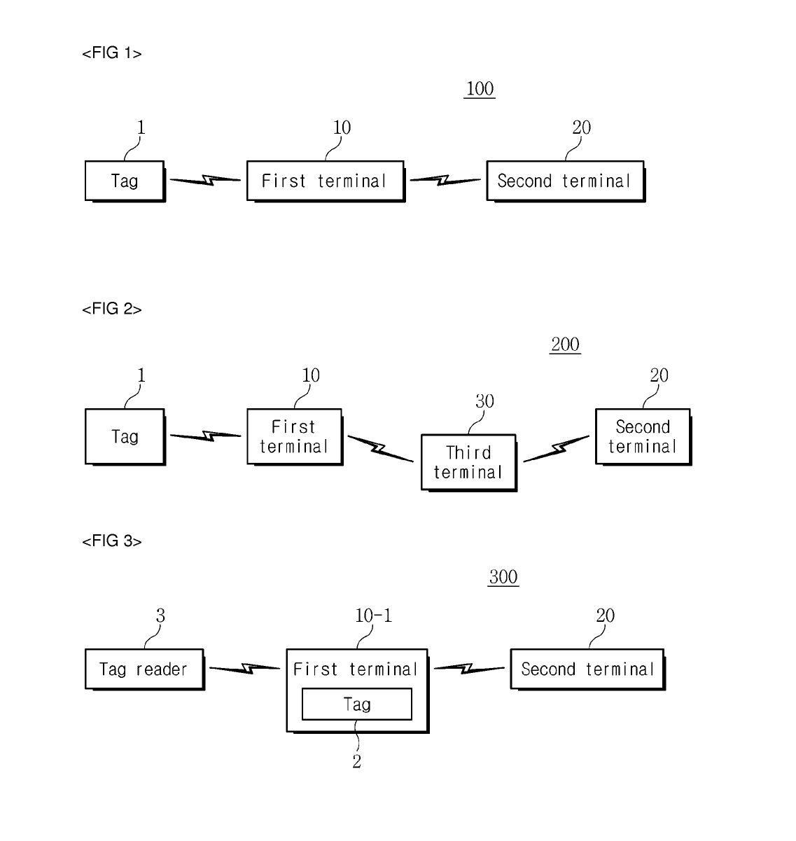

FIG. 1 is a diagram illustrating a configuration of a position measurement system 100 according to an embodiment of the invention.

As illustrated in FIG. 1, the position measurement system 100 according to the embodiment includes a tag 1, and first and second terminals 10 and 20.

The tag 1 is an object that includes, for example, a semiconductor chip, and information stored therein can be identified using a radio frequency in a non-contact manner (radio frequency identification).

The tag 1 may include, for example, an electronic tag, a smart tag, a label, and a card that is attached to or embedded in various objects, regardless of a name or a type thereof.

In the embodiment, a position of the tag 1 is determined, each tag 1 may include information on the position of each tag 1, or address information for accessing a position information server that provides position information of each tag 1.

The first or second terminal 10 or 20 is a terminal that can measure a position by recognizing the tag 1 or through wireless communication with other terminal, and include a tag reader and a wireless communication module.

The first and second terminals 10 and 20 may include any terminal, for example, a cellular phone, a smartphone, a personal digital assistant (PDA), a computer, a laptop, and a consumer product.

In the embodiment, the first terminal 10 reads the tag 1 by a tag reader using, for example, near field communication (NFC) to determine a position of the tag 1, and thereby measures a first position of the adjacent first terminal 10 to recognize the tag 1. In this case, the tag 1 may be a tag that is provided to determine a position of the first terminal 10, or may be one of tags that are recognized by the first terminal 10 when a user of the first terminal 10 purchases products, obtains additional information, or pays for transportation in daily life.

In this case, the first terminal 10 may read the tag 1 and obtain position information of the tag 1, and measure the first position of the adjacent first terminal 10 using the position information. Moreover, the first position of the first terminal 10 adjacent to the tag 1 may be measured such that the first terminal 10 reads the tag 1, obtains access address information of a separate position information server that provides position information of the tag 1, accesses a corresponding position information server using the access address information, and determines the position of the tag 1.

In this case, first position information of the first terminal 10 may include, for example, latitude, longitude, and height information from a reference plane such as the ground, of the position of the first terminal 10.

After the first terminal 10 determines the first position according to the tag 1 position, the first terminal 10 position is changed when a user of the first terminal 10 moves with the first terminal 10. In this case, the first terminal 10 continuously detects a position change of the first terminal 10 from the first position corresponding to the tag 1 position using a sensor provided therein. The first terminal 10 may detect the position change of the first terminal 10 using, for example, a gravity sensor, an acceleration sensor, a gyro sensor, or an optical sensor.

The first terminal 10, which has detected the position change from the first position using the sensor, measures a second position, that is a changed position of the first terminal 10, by reflecting a position change value with respect to the first position. In this case, second position information of the first terminal 10 may include, for example, latitude, longitude, and height information from a reference plane such as the ground, of the position of the first terminal 10.

Thus, the first terminal 10 in the second position wirelessly communicates with the second terminal 20, gradually changes communication power strength, and measures minimum communication power strength capable of communicating between the first and second terminals 10 and 20.

In this case, it is possible to measure minimum communication power strength capable of communicating between the first and second terminals 10 and 20 such that the second terminal 20 broadcasts a message for measuring its own position, and the first terminal 10, that has received a corresponding message, gradually changes communication power strength, and transmits a response message to the second terminal 20. Moreover, it is possible to measure minimum communication power strength capable of communicating between the first and second terminals 10 and 20 such that the second terminal 20 gradually changes communication power strength in response to the response message from the first terminal 10, and transmits a re-response message.

Based on the second position of the first terminal 10, the first or second terminal 10 or 20 measures a third position of the second terminal 20 in consideration of a communication range according to the measured minimum communication power strength. In this case, third position information of the second terminal 20 may include, for example, latitude, longitude, and height information from a reference plane such as the ground, of the position of the second terminal 20.

The first and second terminals 10 and 20 wirelessly communicate using, for example, a wireless personal area network (WPAN) having a communication range of about 10 meters (m). In this case, the following table shows a distance between the first and second terminals 10 and 20 based on communication power strength.

TABLE 1

| Communication | Distance between first and second |
|---|---|
| power strength | terminals 10 and 20 |
| 0 | 0 m |
| 1 | 1 m |
| . | . |
| . | . |
| . | . |
| 10 | 10 m |

As shown in Table 1, communication power strength of 0 refers to a case in which amount of power required for communication between the first and second terminals 10 and 20 is minimum. As communication power strength gradually increases, the amount of power required for communication between the first and second terminals 10 and 20 gradually increases. The amount of power required for communication between the first and second terminals 10 and 20 is maximized in communication power strength of 10.

In addition, when communication power strength between the first and second terminals 10 and 20 is 0, the first and second terminals 10 and 20 are adjacently positioned, and when communication power strength is 1, a distance between the first and second terminals 10 and 20 is about one meter (m). In the same manner, when communication power strength is 10, a distance between the first and second terminals 10 and 20 is about 10 meters (m).

For example, it is possible to measure minimum communication power strength capable of communicating between the first and second terminals 10 and 20 such that the first or second terminal 10 or 20 attempts communication with communication power strength of 0 and then communication power strength is gradually increased until communication can be possible.

In this case, when no communication is performed with communication power strength of 0 but communication is performed with communication power strength of 1, it is understood that a distance between the first and second terminals 10 and 20 is about 1 meter (m). Accordingly, it is understood that the second terminal 20 is positioned in a range of 1 meter (m) from the second position of the first terminal 10, or positioned within the margin of error in which a certain value is added to or subtracted from one meter (m).

In the embodiment, communication power strength is divided into 0 to 10 to measure the position of the second terminal 20, but the invention is not limited thereto. In order to determine the position of the second terminal 20, communication power strength may be divided into various levels. When communication power strength is divided into, for example, 0 to 100, a distance or a range corresponding to communication power strength is further divided so that accuracy in position measurement of the second terminal 20 increases.

In the invention, it is also possible to measure minimum communication power strength capable of communicating between the first and second terminals 10 and 20 such that the first or second terminal 10 or 20 attempts communication with maximum communication power strength, and then gradually decreases communication power strength to find a position incapable of communicating.

In the embodiment of the invention, it is also possible to measure the position of the second terminal 20 using a plurality of first terminals 10 that read the tag 1.

In this case, the plurality of first terminals 10 may measure a first position of each first terminal 10 by respectively reading a different tag 1, or at least one first terminal 10 may read a common tag 1 to measure a first position of each first terminal 10.

Each of the plurality of first terminals 10 detects a position change using a sensor, and measures a second position due to a position change of each of the plurality of first terminals 10.

Then, each of the plurality of first terminals 10 measures minimum communication power strength capable of communicating through wireless communication with the second terminal 20. In this case, in consideration of minimum communication power strength between a second position of a specific first terminal 10 and the second terminal 20, a position of the second terminal 20 is measured. In consideration of a position of the second terminal 20 measured using other first terminal 10, it is possible to relatively accurately detect the position of the second terminal 20. That is, when a distance or a range in which the second terminal 20 is positioned is measured with respect to the second position of the specific first terminal 10, an intersecting position of the distance or the range in which the second terminal 20 is positioned is obtained with respect to a second position of other first terminal 10. Therefore, it is possible to determine that the second terminal 20 is positioned in a corresponding intersecting position.

In the invention, an embodiment in which a position of a third terminal 30 is measured using the positions of the first and second terminals 10 and 20 measured by the above-described method will be described in detail with reference to FIG. 2.

FIG. 2 is a diagram illustrating a configuration of a position measurement system 200 according to another embodiment of the invention.

As illustrated in FIG. 2, the position measurement system 200 according to the embodiment includes a tag 1, and first, second, and third terminals 10, 20, and 30.

In this case, since descriptions of the tag 1, and the first and second terminals 10 and 20 are similar to descriptions made with reference to FIG. 1, hereinafter, description will be made, focusing on differences.

As described with reference to FIG. 1, the first terminal 10 is a terminal that measures a first position corresponding to a position of the tag 1 and measures a second position due to a position change using a sensor.

Moreover, as described with reference to FIG. 1, the second terminal 20 is a terminal that measures minimum communication power strength for wireless communication with the first terminal 10 and in which a position thereof is measured with respect to a second position of the first terminal 10.

In FIG. 2, the third terminal 30 measures minimum communication power strength for wireless communication with at least one terminal between the first and second terminals 10 and 20, and measures a position of the third terminal 30. In this case, the first and second terminals 10 and 20 may be a plurality of terminals.

For example, the third terminal 30 broadcasts a message for position determination, at least one terminal between the first and second terminals 10 and 20, that have received a corresponding message, gradually changes communication power strength for wireless communication, and measures minimum communication power strength capable of communicating with the third terminal 30.

First, based on a third position of the second terminal 20 that is measured by the same method as described in FIG. 1, in consideration of a communication range according to minimum communication power strength for communication between the second and third terminals 20 and 30, it is possible to determine a fourth position of the third terminal 30.

In this case, in a case in which a plurality of fourth positions of the third terminal 30 are determined using a plurality of second terminals 20, when a distance or a range in which the third terminal 30 is positioned is measured with respect to the third position of a specific second terminal 20, an intersecting position of the distance or the range in which the third terminal 30 is positioned is obtained with respect to a third position of other second terminal 20. It is possible to determine that the third terminal 30 is positioned in a corresponding intersecting position.

As technological features of the invention, when the position of the second terminal 20, which does not read the tag 1 directly, is once measured, it is used to measure a position of other third terminal 30. In the invention, it is possible to gradually measure a position of each terminal.

Moreover, the first and third terminals 10 and 30 may measure a fifth position of the third terminal 30 by the same method as that of the first and second terminals 10 and 20 described with reference to FIG. 1, in consideration of a communication range according to minimum communication power strength for communication with the third terminal 30 with respect to the second position of the first terminal 10.

In this case, an intersecting position between a distance or a range in which the third terminal 30 is positioned with respect to the third position of the second terminal 20 and a distance or a range in which the third terminal 30 is positioned with respect to the second position of the first terminal 10 is obtained, and it is possible to determine that the third terminal 30 is positioned in a corresponding intersecting position.

In this case, fourth position information of the third terminal 30 may include, for example, latitude, longitude, and height information from a reference plane such as the ground, of the position of the third terminal 30.

Position measurement of a terminal according to another embodiment of the invention will be described in detail with reference to FIG. 3.

FIG. 3 is a diagram illustrating a configuration of a position measurement system 300 according to another embodiment of the invention.

As illustrated in FIG. 3, the position measurement system 300 according to the embodiment includes a first terminal 10-1, a second terminal 20, and a tag reader 3.

The first and second terminals 10-1 and 20 are terminals that can measure a position through wireless communication with other terminal, and include, for example, a cellular phone, a smartphone, a personal digital assistant (PDA), a computer, a laptop, and a consumer product, which has a wireless communication module.

In this case, a tag 2 capable of being recognized by the tag reader 3 is included inside the first terminal 10-1. The tag 2 may include an active tag having its own power or a passive tag that responds to an electric wave of the tag reader 3 without its own power.

The tag reader 3 reads tag 2 information included in the first terminal 10-1 using, for example, near field communication (NFC) and a position thereof is determined. In this case, the tag 2 and the tag reader 3 may be used when a user of the first terminal 10-1 purchases products, obtains additional information, or pays for transportation in daily life.

In this embodiment, when the user moves the first terminal 10-1 close to the tag reader 3 having a predetermined position, the tag reader 3 reads the tag 2 included in the first terminal 10-1.

In this case, the tag reader 3 transmits position information of the tag reader 3 stored therein to the first terminal 10-1, the first terminal 10-1 determines the position of the tag reader 3 using corresponding position information, and then a first position of the first terminal 10-1 adjacent to the tag reader 3 is measured.

Moreover, it is also possible to measure the first position of the first terminal 10-1 adjacent to the tag reader 3 such that the first terminal 10-1 obtains access address information of a separate position information server that provides position information of the tag reader 3 from the tag reader 3, accesses a corresponding position information server using the access address information, and determines the position of the tag reader 3.

After the first terminal 10-1 determines the first position according to the position of the tag reader 3, the first terminal 10-1 continuously detects a position change using a sensor, for example, a gravity sensor, an acceleration sensor, a gyro sensor, or an optical sensor.

Moreover, the first terminal 10-1 measures a second position, that is a changed position of the first terminal 10-1, by reflecting a position change value detected by the sensor with respect to the first position.

Then, the first terminal 10-1 positioned in the second position wirelessly communicates with the second terminal 20 via a network such as a WPAN, gradually changes communication power strength, and measures minimum communication power strength capable of communicating between the first and second terminals 10-1 and 20.

In this case, it is possible to measure minimum communication power strength capable of communicating between the first and second terminals 10-1 and 20 such that the second terminal 20 broadcasts a message for measuring its own position, and the first terminal 10-1, that has received a corresponding message, gradually changes communication power strength, and transmits a response message to the second terminal 20. Moreover, it is also possible to measure minimum communication power strength capable of communicating such that the second terminal 20 gradually changes communication power strength corresponding to the response message from the first terminal 10-1 and transmits a re-response message.

Based on the second position of the first terminal 10-1, the first or second terminal 10-1 or 20 measures a third position of the second terminal 20 in consideration of a communication range according to the measured minimum communication power strength. In this case, the third position may be information on a distance or a range in which the second terminal 20 can be positioned from the second position of the first terminal 10-1.

When a plurality of first terminals 10-1 measure a first position of each first terminal 10-1 using position information of at least one tag reader 3, and measure a second position of each first terminal 10-1 by detecting a position change using the sensor, an intersecting position of a distance or a range in which the second terminal 20 is positioned from the second position of each first terminal 10-1 is obtained. Therefore, it is possible to determine that the second terminal 20 is positioned in a corresponding intersecting position.

In this way, when the third position of the second terminal 20 is measured, it can be used to measure a position of a corresponding other terminal in consideration of a communication range according to minimum communication power strength for communication between at least one second terminal 20 and other terminal.

Moreover, based on the second position of the first terminal 10-1 and the third position of the second terminal 20, in consideration of a communication range according to minimum communication power strength for communication with other terminal, it is also possible to measure a position of a corresponding other terminal.

In this case, information on the first or second position of the first terminal 10-1, the third position of the second terminal 20, or a position of other terminal may include, for example, latitude, longitude, and height information from a reference plane such as the ground, of the position in which the first terminal 10-1, the second terminal 20, or other terminal is positioned.

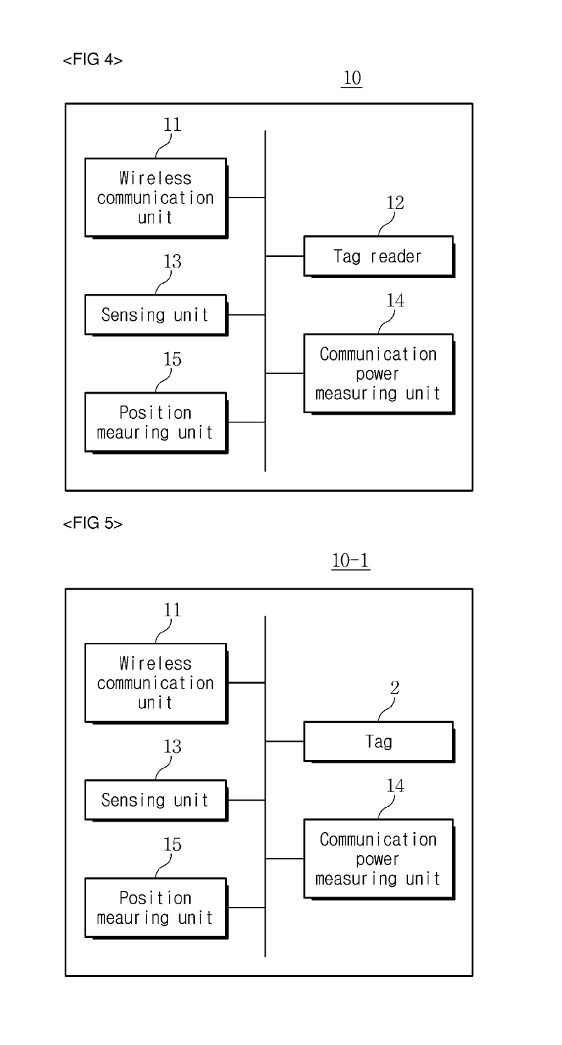

Functions and operations of the first terminal 10 illustrated in FIG. 1 or 2 will be described in detail with reference to FIG. 4.

FIG. 4 is a diagram illustrating a configuration of a first terminal 10 according to an embodiment of the invention.

As illustrated in FIG. 4, the first terminal 10 according to the embodiment includes a wireless communication unit 11, a tag reader 12, a sensing unit 13, a communication power measuring unit 14, and a position measuring unit 15.

The wireless communication unit 11 transmits and receives data via a wireless communication network.

The wireless communication unit 11 may include an interface that can transmit and receive data via, for example, a WPAN.

The tag reader 12 reads information by recognizing an external tag having a predetermined position, and may include, for example, a near field communication (NFC) module.

The tag reader 12 transmits the information obtained by reading the tag to the position measuring unit 15.

The sensing unit 13 detects a position change of the first terminal 10, and may include, for example, a gravity sensor, an acceleration sensor, a gyro sensor, or an optical sensor, to detect the position change.

When wireless communication is performed with other terminal through the wireless communication unit 11, the communication power measuring unit 14 gradually changes communication power strength and measures minimum communication power strength capable of communicating with the other terminal.

The position measuring unit 15 measures a position of the first terminal 10 or a position of other terminal that communicates through the wireless communication unit 11. In the invention, the position measuring unit 15 measures the first position of the first terminal 10 corresponding to an external tag position using the information read by the tag reader 12.

In this case, the position measuring unit 15 may obtain corresponding tag position information from the tag information read by the tag reader 12, and measure the position of the first terminal 10 adjacent to the tag using the information. Moreover, it is also possible to measure the first position of the first terminal adjacent to the tag such that the position measuring unit 15 obtains access address information of a separate position information server, that provides position information of a corresponding tag, from the tag information read by the tag reader 12, accesses a corresponding position information server using the access address information, and determines the position of the tag.

The position measuring unit 15, that has measured the first position of the first terminal 10 adjacent to the tag, measures a second position of the first terminal 20, that is changed from the first position, according to a position change of the first terminal 10 detected by the sensing unit 13. In this case, the position measuring unit 15 may measure the first position, simultaneously perform control such that the sensing unit 13 detects a position change using the sensor, and measure a second position by reflecting a detected position change value with respect to the first position.

Then, when the first terminal 10 positioned in the second position wirelessly communicates with other terminal via, for example, a WPAN, the position measuring unit 15 performs control such that the communication power measuring unit 14 measures minimum communication power strength capable of communicating between the first terminal 10 and other terminal.

In this case, it is possible to measure minimum communication power strength capable of communicating between the first and second terminals 10 and 20 such that a corresponding other terminal broadcasts a message for measuring its own position, and the position measuring unit 15, that has received a corresponding message through the wireless communication unit 11, performs control such that the communication power measuring unit 14 gradually changes communication power strength with the corresponding other terminal, and transmits a response message to other terminal.

Then, based on the second position of the first terminal 10, the position measuring unit 15 measures a third position of other terminal in consideration of a communication range according to the minimum communication power strength measured by the communication power measuring unit 14.

In this case, information on the first or second position of the first terminal 10 and the third position of other terminal may include, for example, latitude, longitude, and height information from a reference plane such as the ground, of the position of the first terminal 10 or other terminal.

Functions and operations of the first terminal 10-1 illustrated in FIG. 3 will be described in detail with reference to FIG. 5.

FIG. 5 is a diagram illustrating a configuration of a first terminal 10-1 according to another embodiment of the invention.

As illustrated in FIG. 5, the first terminal 10-1 according to the embodiment includes a wireless communication unit 11, a sensing unit 13, a communication power measuring unit 14, a position measuring unit 15, and a tag 2.

The tag 2 is recognized by an external tag reader having a predetermined position, and delivers information.

The tag 2 may be one of tags that are recognized by a tag reader when a user of the first terminal 10-1 purchases products, obtains additional information, or pays for transportation in daily life.

The wireless communication unit 11 transmits and receives data via a wireless communication network, and may include an interface that can transmit and receive data via, for example, a WPAN.

The sensing unit 13 detects a position change of the first terminal 10-1 and may include, for example, a gravity sensor, an acceleration sensor, a gyro sensor, or an optical sensor, to detect the position change.

When wireless communication is performed with other terminal through the wireless communication unit 11, the communication power measuring unit 14 gradually changes communication power strength and measures minimum communication power strength capable of communicating with the other terminal.

The position measuring unit 15 measures a position of the first terminal 10-1 or a position of other terminal that communicates through the wireless communication unit 11. In the invention, the position measuring unit 15 receives information from the external tag reader through the wireless communication unit 11, and measures a first position of the first terminal 10-1 corresponding to the external tag reader position.

In this case, the position measuring unit 15 receives position information stored in the external tag reader through the wireless communication unit 11, and determines a position of a corresponding tag reader. In this way, it is possible to measure the position of the first terminal 10-1 adjacent to the tag reader. Moreover, it is also possible to measure a first position of the first terminal adjacent to the tag reader such that the position measuring unit 15 obtains access address information of a separate position information server, that provides position information of a corresponding tag reader, from the information received from the external tag reader through the wireless communication unit 11, accesses a corresponding position information server using the access address information, and determines the position of the tag reader.

The position measuring unit 15, that has measured the first position of the first terminal 10-1 adjacent to the tag, measures a second position of the first terminal 10-1, that is changed from the first position, according to a position change of the first terminal 10-1 detected by the sensing unit 13. In this case, the position measuring unit 15 may measure the first position, simultaneously perform control such that the sensing unit 13 detects a position change using the sensor, and measure a second position by reflecting a detected position change value with respect to the first position.

Then, when the first terminal 10-1 positioned in the second position wirelessly communicates with other terminal via, for example, a WPAN, the position measuring unit 15 performs control such that the communication power measuring unit 14 measures minimum communication power strength capable of communicating between the first terminal 10-1 and other terminal.

In this case, it is possible to measure minimum communication power strength capable of communicating between the first terminal 10-1 and other terminal such that a corresponding other terminal broadcasts a message for measuring its own position, and the position measuring unit 15, that has received a corresponding message through the wireless communication unit 11, performs control such that the communication power measuring unit 14 gradually changes communication power strength with the corresponding other terminal, and transmits a response message to other terminal.

Then, based on the second position of the first terminal 10-1, the position measuring unit 15 measures a third position of other terminal in consideration of a communication range according to the minimum communication power strength measured by the communication power measuring unit 14.

In this case, information on the first or second position of the first terminal 10-1, and the third position of other terminal may include, for example, latitude, longitude, and height information from a reference plane such as the ground, of the position of the first terminal 10-1 or other terminal.

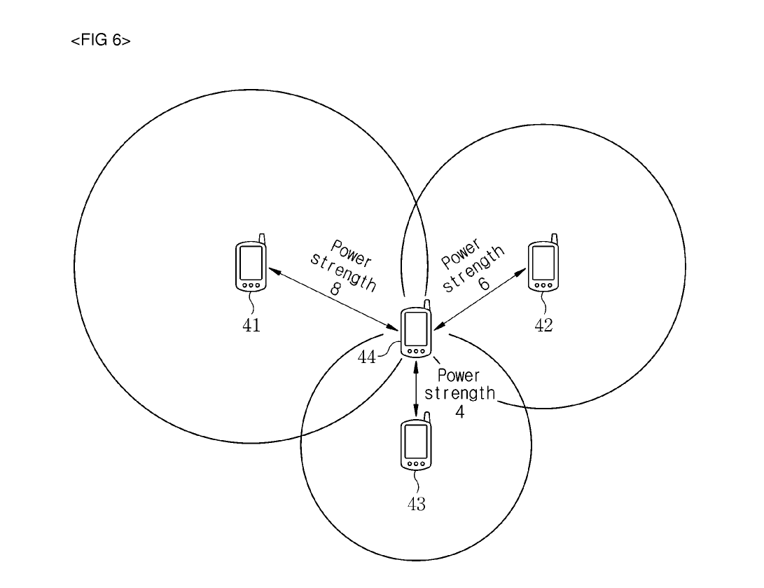

FIG. 6 is a diagram illustrating an example of terminal position measurement according to an embodiment of the invention.

As illustrated in FIG. 6, there are terminals 41, 42, 43, and 44.

According to technological features of the invention, the terminals 41, 42, and 43 are terminals having a predetermined position. That is, the terminals 41, 42, and 43 may include, for example, a terminal in which a position thereof is measured by reading a tag having a predetermined position or by allowing an internal tag to be recognized by a tag reader having a predetermined position, a terminal in which a position thereof is measured by reflecting a position change value detected by a sensor based on an already measured position, and a terminal in which a position thereof is measured using a terminal having an already measured position.

In addition, the terminal 44 is a target terminal in which a position thereof is measured, and the position of the terminal 44 may be measured by wireless communication with the terminals 41, 42, and 43. In this case, the terminals 41, 42, and 43, and the terminal 44 may wirelessly communicate via, for example, a WPAN.

For example, when the terminals 41 and 44 wirelessly communicate each other, wireless communication power strength is gradually changed to measure minimum communication power strength capable of communicating with each other. In this case, minimum communication power strength for communication measured by the terminal 41 or 44 is 8.

Thus, based on an already measured position of the terminal 41, the terminal 41 or 44 measures a position of the terminal 44 in consideration of a communication range according to minimum communication power strength of 8. In this case, a distance or a range in which the terminal 44 can be positioned is displayed as a circle or a sphere around the position of the terminal 41.

Minimum communication power strength for wireless communication between the terminals 42 and 44 measured by the same method is 6. Based on an already measured position of the terminal 42, the terminal 42 or 44 measures a position of the terminal 44 in consideration of a communication range according to minimum communication power strength of 6. In this case, a distance or a range in which the terminal 44 can be positioned is displayed as a circle or a sphere around the position of the terminal 42.

Further, minimum communication power strength for wireless communication between the terminals 43 and 44 measured by the same method is 4. Based on an already measured position of the terminal 43, the terminal 43 or 44 measures a position of the terminal 44 in consideration of a communication range according to minimum communication power strength of 4. In this case, a distance or a range in which the terminal 44 can be positioned is displayed as a circle or a sphere around the position of the terminal 43.

In this case, the positions of the terminal 44 displayed as a circle or a sphere around each of the terminals 41, 42, and 43 intersect at an actual position of the terminal 44. That is, when distances or ranges in which the terminal 44 can be positioned are obtained with respect to each of the terminals 41, 42, and 43, an intersecting position of these distances or ranges can be measured as an actual position of the terminal 44.

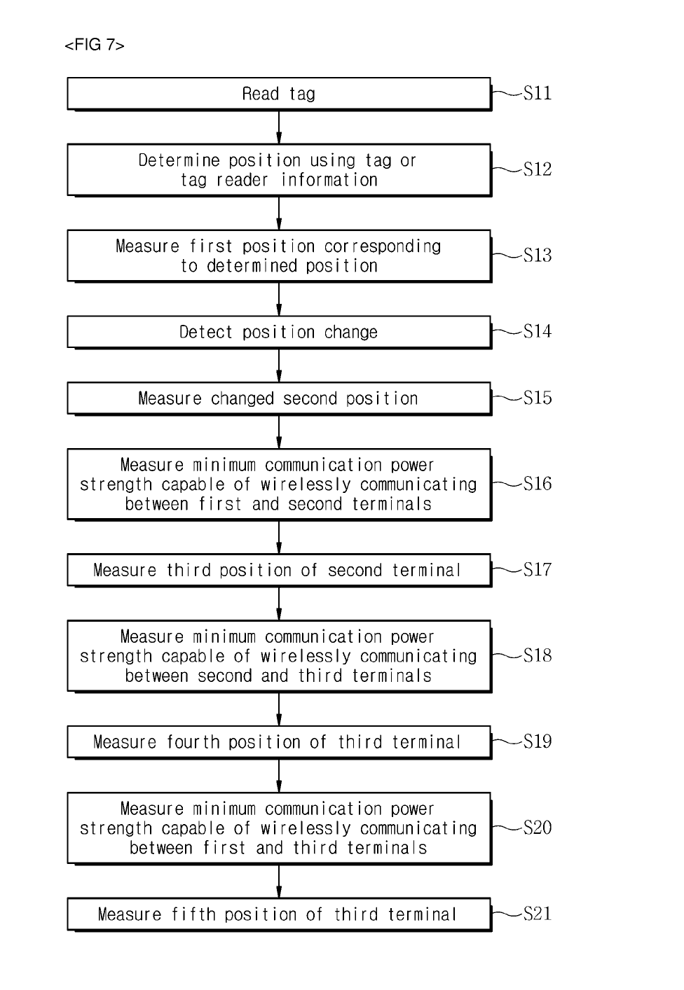

Operations of terminal position measurement according to the invention will be described in detail with reference to FIG. 7.

FIG. 7 is a flowchart illustrating position measurement operations according to an embodiment of the invention.

As illustrated in FIG. 7, when a first terminal reads an external tag having a predetermined position using an internal tag reader, or a first terminal allows an internal tag to be read by an external tag reader having a predetermined position (S11), a position of a corresponding tag or tag reader is recognized using the tag or tag reader information (S12).

In operation (S11), when the first terminal reads the external tag having a predetermined position using the internal tag reader, in operation (S12), it is possible to determine a position of the corresponding tag such that the first terminal reads position information included in the tag or accesses a position information server that provides position information of the tag using the read information.

On the other hand, in operation (S11), when the external tag having a predetermined position reads the internal tag of the first terminal, in operation (S12), it is possible to determine a position of the corresponding tag reader such that the first terminal receives tag reader position information included in the tag reader or accesses a position information server that provides position information of the tag using the information received from the tag reader.

The first terminal that has determined the position of the tag or tag reader in operation (S12) measures a first position of the first terminal corresponding to the determined position (S13).

That is, in order to recognize the tag using the first terminal, since the first terminal needs to be adjacently positioned to the external tag or tag reader, the first terminal may determine a position of the first terminal corresponding to a position of a corresponding tag or tag reader.

In this case, first position information of the first terminal may include, for example, latitude, longitude, and height information from a reference plane such as the ground, of the position of the first terminal. That is, the first terminal can measure latitude, longitude, and height information from a reference plane such as the ground, of the position of the first terminal using position information including, for example, latitude, longitude, and height information, of the position of the tag or the tag reader.

Then, the first terminal continuously detects a position change from the first position using a sensor (S14), and measures a second position of the first terminal that is changed from the first position (S15).

The first terminal in operation (S14) may detect a position change using, for example, a gravity sensor, an acceleration sensor, a gyro sensor, or an optical sensor, and the first terminal in operation (S15) may measure a second position of the first terminal by reflecting the position change value detected in operation (S14) with respect to the first position measured in operation (S13).

In this case, second position information of the first terminal may include, for example, latitude, longitude, and height information from a reference plane such as the ground, of the position of the first terminal. That is, the first terminal may measure latitude, longitude, and a height from a reference plane such as the ground, of the position of the first terminal by detecting a change of the latitude, longitude, or height from the first position due to a position change using the sensor.

The first terminal that has measured the second position in operation (S15) wirelessly communicates with the second terminal. In this case, the first or second terminal measures minimum communication power strength capable of wirelessly communicating each other (S16), and measures a third position of the second terminal (S17).

In operation (S16), when the first or second terminal wirelessly communicates each other via, for example, a WPAN, communication power strength is gradually changed, and minimum communication power strength capable of communicating between the first and second terminals may be measured.

In operation (S16), for example, it is possible to measure minimum communication power strength capable of communicating between the first and second terminals such that the second terminal broadcasts a message for measuring its own position, and the first terminal, that has received a corresponding message, gradually changes communication power strength, and transmits a response message to the second terminal. Moreover, it is possible to measure minimum communication power strength capable of communicating between the first and second terminals such that the second terminal gradually changes communication power strength in response to the response message of the first terminal and transmits a re-response message.

In operation (S17), based on the second position of the first terminal, the first or second terminal may measure a third position of the second terminal in consideration of a communication range according to the measured minimum communication power strength.

According to the embodiment of the invention, a plurality of first terminals measure a first position by determining a position of a tag or a tag reader, respectively measure a second position due to a position change, and then measure a third position of the second terminal through wireless communication with the second terminal. In this case, when a distance or a range in which the second terminal is positioned is measured with respect to the second position of the specific first terminal, an intersecting position of the distance or range in which the second terminal is positioned is obtained with respect to a second position of other first terminal. Therefore, it is possible to determine that the second terminal is positioned in a corresponding intersecting position.

In operation (S17), when a third position of the second terminal is measured, the second terminal wirelessly communicates with a third terminal in which a position thereof is not determined. In this case, the second or third terminal measures minimum communication power strength capable of wirelessly communicating each other (S18), and measures a fourth position of the third terminal (S19).

In operation (S18), when the second or third terminal wirelessly communicates each other via, for example, a WPAN, communication power strength is gradually changed, and minimum communication power strength capable of communicating between the second and third terminals may be measured. In operation (S19), based on the third position of the second terminal, the second or third terminal may measure a fourth position of the third terminal in consideration of a communication range according to the measured minimum communication power strength. In this case, it is also possible to measure the fourth position of the third terminal using a plurality of second terminals.

Since measurement of the fourth position of the third terminal through wireless communication between the second and third terminals in operations (S18 to S19) is similar to measurement of the third position of the second terminal in operations (S16 to S17), detailed description thereof will not be repeated.

In the invention, other than the first terminal in which a position thereof is measured by closing to the tag or tag reader, the second terminal in which a position thereof is already measured using technological features of the invention is used to measure a position of other third terminal.

Moreover, in operation (S19), when the fourth position of the third terminal is measured, the first terminal wirelessly communicates with the third terminal. In this case, the first or third terminal measures minimum communication power strength capable of wirelessly communicating each other (S20), and measures a fifth position of the third terminal (S21).

In operation (S20), when the first or third terminal wirelessly communicates each other via, for example, a WPAN, communication power strength is gradually changed, and minimum communication power strength capable of communicating between the first and third terminals may be measured. In operation (S21), based on the second position of the first terminal, the first or third terminal may measure a fifth position of the third terminal in consideration of a communication range according to the measured minimum communication power strength.

According to the invention, the first terminal in which a position thereof is determined using a position of a tag or a tag reader and a position thereof is measured due to a position change, and the second terminal in which a position thereof is already measured may be simultaneously used to measure a position of the third terminal.

In this case, fourth or fifth position information of the third terminal may include, for example, latitude, longitude, and height information from a reference plane such as the ground, of the position of the third terminal.

A position measurement method according to the embodiment of the invention may be implemented as a program type that can be read by various computer means and stored in a computer readable recording medium.

Embodiments described in this specification and drawings are just examples to facilitate understanding, and the invention is not limited thereto. It is apparent to those skilled in the art that various modifications based on the technological scope of the invention in addition to the embodiments disclosed herein can be made. Moreover, while specific terms are used in this specification and drawings, these are used with general meanings to easily describe technological content of the invention and to help understanding of the invention, and the invention is not limited thereto.

According to the invention, the method of measuring a terminal position using a tag and the terminal thereof may have the following advantages.

First, it is possible to accurately measure positions of a plurality of terminals since a position of a specific terminal is determined based on a tag or a tag reader which has an accurately determined position, a position change due to terminal movement is detected using a sensor, and a position of other terminal is determined based on a position of a terminal that moves.

Second, it is possible to improve convenience for position measurement. This is because the specific terminal needs tag recognition but other terminal, that recognizes a position thereof using a corresponding specific terminal, does not necessarily recognize the tag.

Third, it is possible to accurately measure positions of the plurality of terminals regardless of radio environments, for example, indoor areas, since the terminal in which a position thereof is determined once can be used for position determination of other terminal.

1-25. (canceled)

26. A method of measuring a terminal position using a tag, comprising:
measuring a first position of a first terminal such that the first terminal reads a tag having a predetermined position and measures the first position corresponding to the position of the tag;
measuring a second position of the first terminal such that the first terminal continuously detects a position change from the first position using a sensor and measures the changed second position of the first terminal;
measuring communication power such that, when the first or second terminal wirelessly communicates each other, communication power strength is gradually changed, and minimum communication power strength capable of communicating is measured; and
measuring a third position of the second terminal by the first or second terminal based on the second position in consideration of a communication range according to the measured minimum communication power strength.

27. The method of claim 26, wherein, in the measuring of the first position, the first terminal reads position information included in the tag, determines the position of the tag, and measures the first position corresponding to the determined position of the tag.

28. The method of claim 26, wherein, in the measuring of the first position, the first terminal reads information included in the tag, accesses a position information server that provides position information of the tag, determines the position of the tag, and measures the first position corresponding to the determined position of the tag.

29. A method of measuring a terminal position using a tag, comprising:
measuring a first position of a first terminal such that a tag reader having a predetermined position reads a tag included in the first terminal and the first position of the first terminal is measured corresponding to the position of the tag reader;
measuring a second position of the first terminal such that the first terminal continuously detects a position change from the first position using a sensor and measures the changed second position of the first terminal;
measuring communication power such that, when the first or second terminal wirelessly communicates each other, communication power strength is gradually changed, and minimum communication power strength capable of communicating is measured; and
measuring a third position of the second terminal by the first or second terminal based on the second position in consideration of a communication range according to the measured minimum communication power strength.

30. The method of claim 29, wherein, in the measuring of the first position, the first terminal receives position information stored in the tag reader, determines the position of the tag reader, and measures the first position corresponding to the determined position of the tag reader.

31. The method of claim 29, wherein, in the measuring of the first position, the first terminal receives information included in the tag reader, accesses a position information server that provides position information of the tag reader, determines the position of the tag reader, and measures the first position corresponding to the determined position of the tag reader.

32. The method of claim 26, wherein, in the measuring of the second position, the first terminal detects the position change of the first terminal using a gravity sensor, an acceleration sensor, a gyro sensor, or an optical sensor.

33. The method of claim 26, wherein, in the measuring of the second position, the plurality of first terminals and the second terminal wirelessly communicate each other and respectively measure minimum communication power strength capable of communicating, and in the measuring of the third position, the third position is measured based on each position of the plurality of first terminals in consideration of a communication range according to each minimum communication power strength.

34. The method of claim 29, wherein, in the measuring of the second position, the plurality of first terminals and the second terminal wirelessly communicate each other and respectively measure minimum communication power strength capable of communicating, and in the measuring of the third position, the third position is measured based on each position of the plurality of first terminals in consideration of a communication range according to each minimum communication power strength.

35. The method of claim 26, wherein, in the measuring of the communication power, the first or second terminal wirelessly communicates via a wireless personal area network (WPAN) and measures minimum communication power strength capable of communicating.

36. The method of claim 26, wherein, in the measuring of the communication power, the second terminal broadcasts a message for position determination, and the first terminal, that has received the message for position determination, gradually changes communication power strength, and transmits a response message to the second terminal so that minimum communication power strength capable of communicating is measured.

37. The method of claim 29, wherein, in the measuring of the communication power, the second terminal broadcasts a message for position determination, and the first terminal, that has received the message for position determination, gradually changes communication power strength, and transmits a response message to the second terminal so that minimum communication power strength capable of communicating is measured.

38. The method of claim 26, wherein, in the measuring of the third position, based on the second position, a distance or a range in which the second terminal is positioned is measured.

39. The method of claim 29, wherein, in the measuring of the third position, based on the second position, a distance or a range in which the second terminal is positioned is measured.

40. The method of claim 26, further comprising:
measuring second communication power such that, when the second or third terminal wirelessly communicates each other, communication power strength is gradually changed, and minimum communication power strength capable of communicating is measured; and
measuring a fourth position of the third terminal such that the second or third terminal measures the fourth position of the third terminal based on the third position in consideration of a communication range according to the minimum communication power strength measured in the measuring of the second communication power.

41. The method of claim 29, further comprising:
measuring second communication power such that, when the second or third terminal wirelessly communicates each other, communication power strength is gradually changed, and minimum communication power strength capable of communicating is measured; and
measuring a fourth position of the third terminal such that the second or third terminal measures the fourth position of the third terminal based on the third position in consideration of a communication range according to the minimum communication power strength measured in the measuring of the second communication power.

42. The method of claim 40, further comprising:
measuring third communication power such that, when the first or third terminal wirelessly communicates each other, communication power strength is gradually changed, and minimum communication power strength capable of communicating is measured; and
measuring a fifth position of the third terminal such that the first, second, or third terminal measures the fifth position of the third terminal based on the second and third positions in consideration of a communication range according to the minimum communication power strength measured in the measuring of the third power and the fourth position.

43. The method of claim 41, further comprising:
measuring third communication power such that, when the first or third terminal wirelessly communicates each other, communication power strength is gradually changed, and minimum communication power strength capable of communicating is measured; and
measuring a fifth position of the third terminal such that the first, second, or third terminal measures the fifth position of the third terminal based on the second and third positions in consideration of a communication range according to the minimum communication power strength measured in the measuring of the third power and the fourth position.

44. The method of claim 26, wherein the first, second, or third position includes at least one of latitude, longitude, and height information from a reference plane.

45. A terminal for measuring a position using a tag, comprising:
a wireless communication unit for wireless communication;
a tag reader configured to read information of a tag having a predetermined position;
a sensing unit configured to detect position movement;
a communication power measuring unit configured to, when wireless communication is performed with other terminal through the wireless communication unit, gradually change communication power strength, and measure minimum communication power strength capable of communicating; and
a position measuring unit configured to measure a first position using the information read by the tag reader, measure a changed second position by continuously detecting a position change from the first position by the sensing unit, and measure a third position of a second terminal based on the second position in consideration of a communication range according to the minimum communication power strength measured by the communication power measuring unit.
